(19) United States
(12) Patent Application Publication
(10) Pub. No.: US 2026/0054885 A1
(43) Pub. Date: Feb. 26, 2026

(54) Paper Packaging Bag with Ziplock

(71) Applicant: Yam Man Tsoi, Dongguan (CN)

(72) Inventor: Yam Man Tsoi, Dongguan (CN)

(21) Appl. No.: 19/375,207

(22) Filed: Oct. 31, 2025

Related U.S. Application Data
(63) Continuation-in-part of application No. 18/383,467, filed on Oct. 24, 2023.
Application No. 18/383,467 is a continuation of application No. PCT/CN2023/082383, filed on Mar. 20, 2023.

(30) Foreign Application Priority Data
Nov. 14, 2022 (CN) 202223038551.6

(51) Int. Cl. B65D 33/25; B31B 70/62; B31B 70/74; B31B 70/88; B31B 160/10; B31B 170/10; B32B 7/12; B32B 27/10; B32B 27/32; B65D 30/00

(52) U.S. Cl. CPC B65D 33/2589; B31B 70/62; B31B 70/79; B31B 70/88; B32B 7/12; B32B 27/10; B32B 27/32; B65D 31/00; B31B 2160/10; B31B 2170/10; B32B 2250/02; B32B 2439/06

(57) ABSTRACT

The present application discloses a paper packaging bag with a ziplock, which comprises two bag sheets formed by folding a paper material, a ziplock, and two paper connecting strips. The side edges of the two bag sheets are connected to form a containing cavity; the ziplock is fixed at an opening of the containing cavity via the two paper connecting strips. Wherein, each paper connecting strip comprises a paper strip, a hot-melt adhesive layer and a film layer. The hot-melt adhesive layer is used for hot-press bonding with the bag sheets, and the film layer is used for hot-press bonding with the ziplock. The paper packaging bag with a ziplock realizes the combination of the ziplock and the paper bag by means of the paper connecting strips, thereby improving the usage convenience of the paper packaging bag and achieving better environmental protection.

### CROSS REFERENCE TO RELATED APPLICATIONS

The present application is a Continuation-in-Part Application of U.S. Non-Provisional patent application Ser. No. 18/383,467, filed on Oct. 24, 2023, entitled “Packaging Bag with Ziplock”. The patent application Ser. No. 18/383,467 is a Continuation Application of PCT Application No. PCT/CN2023/082383 filed on Mar. 20, 2023, which claims priority of Chinese Patent Application No.202223038551.6 filed on Nov. 14, 2022, the entire contents of which are incorporated herein by reference.

### TECHNICAL FIELD

This present application relates to the technical field of packaging bag products, in particular relates to a paper packaging bag with a ziplock.

### BACKGROUND

Market-available packaging bags are generally categorized into two major types, namely plastic packaging bags and paper packaging bags.

Plastic packaging bags are typically equipped with ziplock closures. Such bags feature convenient usage and reusability, yet the plastic material fails to meet environmental protection requirements under certain scenarios.

In accordance with existing structural designs and production methods, paper packaging bags cannot achieve combination with ziplock closures. Sealing of paper bag openings usually relies on adhesive application. However, for packaging bags adopting this adhesive-sealing method, the adhesiveness tends to lose effectiveness after prolonged use. This phenomenon results in failure to seal the bag openings, thereby causing inconvenience in usage and limiting the service life of the packaging bags.

In view of the above, there is an urgent demand in the market for a packaging bag that can simultaneously satisfy both environmental protection requirements and usage convenience.

### SUMMARY

In order to overcome the shortcomings of existing technical solutions, the embodiment of the present application provides a paper packaging bag with a ziplock.

The technical solution adopted in the present application to solve the above-mentioned technical problem is:

A paper packaging bag with a ziplock, including:
a first bag sheet and a second bag sheet formed by folding a paper material, wherein each of two vertical edges of the first bag sheet include a connecting end, each of two vertical edges of the second bag sheet include another connecting end, and the connecting end of the first bag sheet is disposed opposite to and connected with the connecting end of the second bag sheet, thereby defining a containing cavity configured for holding items;
a ziplock disposed at an opening of the containing cavity, the ziplock including a first locking member and a second locking member that are configured to be snap-fitted to each other; and
a first paper connecting strip and a second paper connecting strip, each of which including a paper strip, a hot-melt adhesive layer disposed on one side of the paper strip, and a film layer disposed on the other side of the paper strip;
wherein the first paper connecting strip is disposed between the first locking member and the first bag sheet, the hot-melt adhesive layer of the first paper connecting strip faces a first inner side of the first bag sheet, and the film layer of the first paper connecting strip faces the first locking member; the first locking member is fixed to the first inner side of the first bag sheet via the first paper connecting strip by means of hot-pressing treatment;
the second paper connecting strip is disposed between the second locking member and the second bag sheet, the hot-melt adhesive layer of the second paper connecting strip faces a second inner side of the second bag sheet, and the film layer of the second paper connecting strip faces the second locking member; and the second locking member is fixed to the second inner side of the second bag sheet via the second paper connecting strip by means of hot-pressing treatment.

Further, the hot-melt adhesive layer is covered on one side of the paper strip by means of a printing process.

Further, the film layer is covered on the other side of the paper strip by means of a coating process.

Further, both the film layer and the ziplock are made of Polyethylene.

Further, the first locking member includes a first connecting piece and a fastening portion disposed on the first connecting piece, and the first connecting piece is disposed on the first inner side of the first bag sheet and extends along both ends of the first inner side of the first bag sheet.

Further, the first connecting piece is combined with the film layer of the first paper connecting strip by means of hot-pressing treatment.

Further, the width of the film layer of the first paper connecting strip is greater than or equal to the width of the first connecting piece.

Further, the second locking member includes a second connecting piece and a locking portion disposed on the second connecting piece, and the second connecting piece is disposed on the second inner side of the second bag sheet and extends along both ends of the first inner side of the first bag sheet.

Further, the second connecting piece is combined with the film layer of the second paper connecting strip by means of hot-pressing treatment.

Further, wherein the width of the film layer of the second paper connecting strip is greater than or equal to the width of the first connecting piece.

Further, the locking portion includes a first locking portion and a second locking portion, one end of the first locking portion being disposed opposite to and separated from one end of the second locking portion by a predetermined distance so as to form a locking cavity for securing the first locking member.

Further, the first locking portion and the second locking portion are both provided with a locking element, and the locking element of the first locking portion and the locking element of the second locking portion both extend at least partially toward the locking cavity;
when the first locking member is embedded in the locking cavity, the first locking member is secured by means of the locking element of the first locking portion and the locking element of the second locking portion.

Further, the first bag sheet includes a first tear-off bag sheet with the first locking member placed thereon, and a first tear-off line is provided at the juncture of the first tear-off bag sheet with the first bag sheet;
the second bag sheet includes a second tear-off bag sheet with the second locking member placed thereon, and a second tear-off line is provided at the juncture of the second tear-off bag sheet with the second bag sheet.

Compared with the existing technology, the beneficial effects of the present application are as follows:

The paper packaging bag with a ziplock of the present application includes two bag sheets formed by folding a paper material, a ziplock, and two paper connecting strips. The side edges of the two bag sheets are connected to form a containing cavity; the ziplock is fixed at an opening of the containing cavity via the two paper connecting strips. Wherein, each paper connecting strip includes a paper strip, a hot-melt adhesive layer and a film layer. The hot-melt adhesive layer is used for hot-press bonding with the bag sheets, and the film layer is used for hot-press bonding with the ziplock. The paper packaging bag with a ziplock realizes the combination of the ziplock and the paper bag by means of the paper connecting strips, thereby improving the usage convenience of the paper packaging bag and achieving better environmental protection.

### BRIEF DESCRIPTION OF THE DRAWINGS

In order to more clearly illustrate the embodiments of the present application, the drawings used in the embodiments will be briefly described below. Obviously, the drawings in the following description are merely some embodiments of the present application, and other drawings may be obtained by those skilled in the art without any creative work.

FIG. 1 is a structural diagram of an embodiment of the present application in which a first bag sheet is separated from a second bag sheet;

FIG. 2 illustrates a structural diagram of a second locking member and a first locking member of an embodiment of the present application;

FIG. 3 illustrates a connection structure between a first paper connecting strip, a first bag sheet and a first connecting sheet; and

FIG. 4 illustrates a connection structure between a second paper connecting strip, a second bag sheet and a second connecting sheet.

### REFERENCE NUMERALS IN THE DRAWINGS

1. first bag sheet; 11. first inner side; 12. first tear-off bag sheet; 121. first tear-off line; 2. second bag sheet; 21. second inner side; 22. second tear-off bag sheet; 221. second tear-off line; 3. connecting end; 4. second locking member; 41. second connecting piece; 42. locking portion; 421. first locking portion; 422. second locking portion; 423. locking element; 43. locking cavity; 5. first locking member; 51. first connecting piece; 52. fastening portion; 521. first raised area; 522. second raised area; 61. first paper connecting strip; 62. second paper connecting strip; 6A. paper strip; 6B. hot-melt adhesive layer; 6C. film layer.

### DETAILED DESCRIPTION

The technical solutions in the embodiments of the present application will be clearly and completely described below with reference to the accompanying drawings of the embodiments of the application. It is apparent that the embodiments to be described below are merely a part of the embodiments of the present application, and not all of them. All other embodiments obtained by those skilled in the art based on the embodiments of the present application without creative efforts are within the scope of the present application.

It should be understood that, when used in this specification and the appended claims, the terms “include” and “comprise” indicate the presence of the described features, integers, steps, operations, elements and/or components, but do not preclude the presence or addition of a plurality of other features, integers, steps, operations, elements, components, and/or collections thereof.

It should also be understood that, the terms used in the specification of the present application are only for descriptive purpose and are not intended to limit the present application. As used in the embodiment of the present application and in the appended claims, the singular forms “a”, “an” and “the” are intended to include the plural forms unless the context clearly indicate otherwise.

It should be further understood that the term “and/or” used in the specification of the present application and the appended claims refers to any combination and all possible appended claims refers to any combination and all possible combination of one or more the associated items listed, and includes these combinations.

The paper packaging bag with a ziplock of the present application includes two bag sheets formed by folding a paper material, a ziplock, and two paper connecting strips. The side edges of the two bag sheets are connected to form a containing cavity; the ziplock is fixed at an opening of the containing cavity via the two paper connecting strips. Wherein, each paper connecting strip includes a paper strip, a hot-melt adhesive layer and a film layer. The hot-melt adhesive layer is used for hot-press bonding with the bag sheets, and the film layer is used for hot-press bonding with the ziplock. The paper packaging bag with a ziplock realizes the combination of the ziplock and the paper bag by means of the paper connecting strips, thereby improving the usage convenience of the paper packaging bag and achieving better environmental protection.

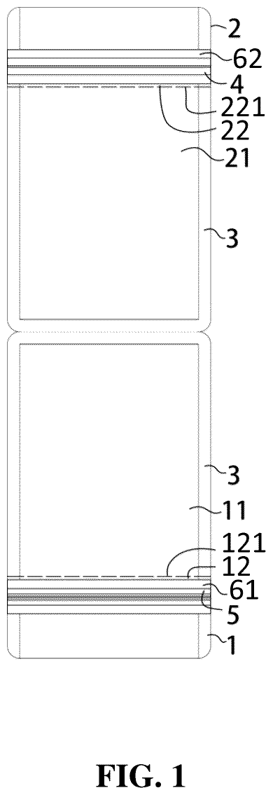

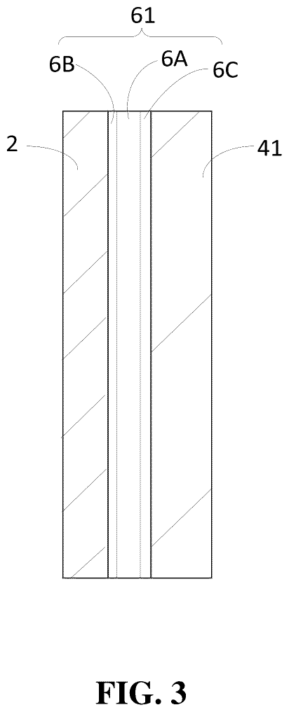

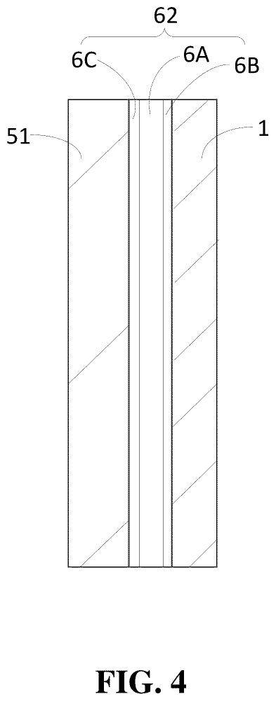

As shown in FIGS. 1-4, the paper packaging bag with a ziplock in this embodiment includes a first bag sheet 1 and a second bag sheet 2 formed by folding a paper material, a ziplock (4, 5), and a first paper connecting strip 61 and a second paper connecting strip 62.

Each of two vertical edges of the first bag sheet 1 include a connecting end 3, each of two vertical edges of the second bag sheet 2 include another connecting end 3, and the connecting end 3 of the first bag sheet 1 is disposed opposite to and connected with the connecting end 3 of the second bag sheet 2, thereby defining a containing cavity configured for holding items.

The ziplock (4, 5) is disposed at an opening of the containing cavity, the ziplock (4, 5) including a first locking member 5 and a second locking member 4 that are configured to be snap-fitted to each other.

The first paper connecting strip 61 and the second paper connecting strip 62 have the same structure, and each of them includes a paper strip 6A, a hot-melt adhesive layer 6B disposed on one side of the paper strip 6A, and a film layer 6C disposed on the other side of the paper strip 6A.

The first paper connecting strip 61 is disposed between the first locking member 5 and the first bag sheet 1, the hot-melt adhesive layer 6B of the first paper connecting strip 61 faces a first inner side 11 of the first bag sheet 1, and the film layer 6C of the first paper connecting strip 61 faces the first locking member 5; the first locking member 5 is fixed to the first inner side 11 of the first bag sheet 1 via the first paper connecting strip 61 by means of hot-pressing treatment.

The second paper connecting strip 62 is disposed between the second locking member 4 and the second bag sheet 2, the hot-melt adhesive layer 6B of the second paper connecting strip 62 faces a second inner side 21 of the second bag sheet 2, and the film layer 6C of the second paper connecting strip 62 faces the second locking member 4; and the second locking member 4 is fixed to the second inner side 21 of the second bag sheet 2 via the second paper connecting strip 62 by means of hot-pressing treatment.

In this embodiment, both of the first bag sheet 1 and the second bag sheet 2 are constructed from paper, ensuring a sustainable and eco-friendly packaging solution. Furthermore, the packaging bag is equipped with a ziplock (4, 5) which replaces the previous snap-in and locking mechanisms. The ziplock (4, 5) ensures that the opening of the paper bag can be easily sealed and reopened multiple times, eliminating the need for adhesives or tape.

In this embodiment, two vertical edges of the first bag sheet 1 and two vertical edges of the second bag sheet 2 are provided with a connecting end 3, and the connecting end 3 of the first bag sheet 1 and the connecting end 3 of the second bag sheet 2 are connected together with each other. Specifically, adhesive can be chosen to be coated on the connecting end 3 of the first bag sheet 1 and the connecting end 3 of the second bag sheet 2, then the connecting end 3 of the first bag sheet 1 is provided opposite to the connecting end 3 of the second bag sheet 2 and is connected to the connecting end 3 of the second bag sheet 2. The connecting end 3 of the second bag sheet 2 is connected to the connecting end 3 of the second bag sheet 2, thus forming a containing cavity for loading items, and the connecting end 3 of the first bag sheet 1 and the connecting end 3 of the second bag sheet 2 are set opposite to each other in terms of outer diameter and position, so as to make the first bag sheet 1 and the second bag sheet 2 connected to each other. When storing an item temporarily, the item is simply placed into the containing cavity through the opening between the first bag sheet 1 and the second bag sheet 2.

In this embodiment, the hot-melt adhesive layer 6B is covered on one side of the paper strip 6A by means of a printing process. Based on this, uniform coating of the hot-melt adhesive layer 6B can be achieved to ensure stable bonding strength; precise control of the gluing pattern and area can be realized to reduce adhesive waste; it adapts to the continuous paper processing flow, improves production efficiency, and ensures bonding reliability.

In this embodiment, the film layer 6C is covered on the other side of the paper strip 6A by means of a coating process. Specifically, a continuous film can be formed by uniformly applying liquid film material (such as resin solution) on the paper surface, followed by drying/curing. This can be specifically achieved using a roll coating method. Multiple sets of rollers (such as coating rollers and metering rollers) are used to control the coating thickness, transfer the film material (such as polyethylene) to the paper surface, and then dry and cure it through an oven. The coating process enables uniform and tight film layers, precise control of thickness, improved barrier properties, and adaptation to continuous processing to enhance production efficiency.

In this embodiment, both the film layer 6C and the ziplock (4, 5) are made of Polyethylene so as to achieve better bonding through the hot-pressing treatment.

The first locking member 5 includes a first connecting piece 51 and a fastening portion 52 disposed on the locking portion 51. The second locking member 4 includes a second connecting piece 41 and a locking portion 42 disposed on the second connecting piece 41.

The locking portion 51 is combined with the film layer 6C of the first paper connecting strip 61 and the second connecting piece 41 is combined with the film layer 6C of the second paper connecting strip 62 by means of hot-pressing treatment.

The width of the film layer 6C of the second paper connecting strip 62 is greater than or equal to the width of the locking portion 51, and the width of the film layer 6C of the first paper connecting strip 61 is greater than or equal to the width of the locking portion 51 to make sure that the locking portion 51 is fully bonding with the second paper connecting strip 62 and the second connecting piece 41 is fully bonding with the second paper connecting strip 62.

In this embodiment, the first locking member 5 is provided on a first inner side 11 of the first bag sheet 1. The first locking member 5 is specifically provided at an opening on the first inner side 11 of the first bag sheet 1, in an upper side position of the first inner side 11 of the first bag sheet 1. The first inner side 11 of the first bag sheet 1 and the second inner side 21 of the second bag sheet 2 are provided opposite to each other, i.e., both the first inner side 11 of the first bag sheet 1 and the second inner side 21 of the second bag sheet 2 are oriented toward the containing cavity, thus, when the opening of the bag is sealed, the first inner side 11 of the first bag sheet 1 and the second inner side 21 of the second bag sheet 2 may be affixed to each other to store the items temporarily.

In this embodiment, the second locking member 4 is provided on the second inner side 21 of the second bag sheet 2. The second locking member 4 is specifically provided at the opening on the second inner side 21 of the second bag sheet 2, in an upwardly facing position on the second inner side 21 of the first bag sheet 1, and in a position corresponding to the position of the first locking member 5.

When the first locking member 5 is fastened to the second locking member 4, the opening of the bag in communication with the containing cavity is sealed. Specifically, the first locking member 5 is aligned with the second locking member 4, and the first locking member 5 is embedded in the second locking member 4, and the opening of the bag is sealed by snapping the first locking member 5 to the second locking member 4.

When the first locking member 5 is disengaged from the second locking member 4, the sealed opening is opened, specifically by pulling the first locking member 5 out of the second locking member 4 with force, so that the second locking member 4 releases its locking action on the first locking member 5, at which point the opening is opened and the item can be placed into the containing cavity.

The second connecting piece 41 is provided on the first inner side 11 of the first bag sheet 1, the second connecting piece 41 is specifically provided at the opening of the bag on the first inner side 11 of the first bag sheet 1, and the second connecting piece 41 extends along the two ends of the first inner side 11, specifically to a first end and a second end of the first inner side 11, so that the length of the two ends of the second connecting piece 41 is the same as that of the two ends of the locking portion 42. The locking portion 42 is provided on the second connecting piece 41, so that after the locking portion 42 locks the first locking member 5, the opening of the bag is almost sealed, and there is no unsealed portion between the first bag sheet 1 and the second bag sheet 2.

The locking portion 42 includes a first locking portion 421 and a second locking portion 422, one end of the first locking portion 421 being disposed opposite to and separated from the end of the second locking portion 422 by a predetermined distance, which is smaller than the outer diameter of the first locking member 5, so as to form a locking cavity 43 for securing the first locking member 5. The locking cavity 43 has a cavity shape that matches the shape of the first locking member 5. Specifically, the first locking portion 421 and the second locking portion 422 have the same shape, and one end of the first locking portion 421 and one end of the second locking portion 422 extend partially from each other. When the first locking member 5 is embedded in the locking cavity 43, the first locking member 5 is secured by the first locking portion 421 and the second locking portion 422, preventing the first locking member 5 from detaching out of the locking cavity 43 easily without a person pulling out of the first locking member 5 by force, and enabling the first locking member 5 to be firmly held in the locking cavity 43 between the first locking portion 421 and the second locking portion 422.

In addition, the first locking member 5 will squeeze the first lock portion 421 and the second lock portion 422 when it is embedded in the locking cavity 43 to deform them, so that the first locking member 5 is completely embedded in the locking cavity 43, and the first lock portion 421 and the second lock portion 422 will automatically return to their original shape after being squeezed and deformed.

The first locking portion 421 and the second locking portion 422 are both provided with a locking element 423, and the locking element 423 of the first locking portion 421 and the locking element 423 of the second locking portion 422 both extend at least partially in the direction of the locking cavity 43, but the locking element 423 of the first locking portion 421 and the locking element 423 of the second locking portion 422 are not connected with each other, and the two of them are separated from each other by a predetermined distance. The locking element 423 of the first locking portion 421 and the locking element 423 of the second locking portion 422 are in contact with the outer surface of the first locking member 5 for catching the first locking member 5 and preventing the first locking member 5 from easily disengaging from the locking cavity 43.

When the first locking member 5 is embedded in the locking cavity 43, the first locking member 5 is secured by means of the locking element 423 of the first locking portion 421 and the locking element 423 of the second locking portion 422, specifically by means of the locking element 423 of the first locking portion 421 and the locking element 423 of the second locking portion 422, the first locking member 5 is prevented from being disengaged outwardly out of the locking cavity 43 unless force is exerted to pull the first locking member 5 outwardly out of the locking cavity 43.

The locking element 423 of the first locking portion 421 and the locking element 423 of the second locking portion 422 described above are both made of an elastic material, which is, for example, a thermosetting elastic material or a thermoplastic elastic material (TPE). The thermoplastic elastic material is a polymer material that combines the properties of plastic and rubber, displays the high elasticity of rubber at room temperature, and can be plasticized and molded at high temperatures. The structure of thermoplastic elastomer is characterized by chemical bonding of different resin and rubber segments, with the resin segments forming physical cross-linking points by virtue of inter-chain forces, and the rubber segments being highly elastic chain segments. Therefore, when the first locking member 5 is embedded in the locking cavity 43, it squeezes the locking element 423 of the first locking portion 421 and the locking element 423 of the second locking portion 422, causing the locking element 423 of the first locking portion 421 and the locking element 423 of the second locking portion 422 to be deformed. When the first locking member 5 is fully embedded in the locking cavity 43, the locking element 423 of the first locking portion 421 and the locking element 423 of the second locking portion 422 will automatically spring back to restore the original shape.

The first locking member 5 includes a first connecting piece 51 and a fastening portion 52. The fastening portion 52 is used to be embedded in the locking cavity 43 such that the opening of the bag is sealed. The first connecting piece 51 is provided on the second inner side 21 of the second bag sheet 2, the first connecting piece 51 is specifically provided at the opening of the bag on the second inner side 21 of the second bag sheet 2, and the first connecting piece 51 extends along the two ends of the second inner side 21, specifically to the first end and the second end of the second inner side 21, so that the lengths of the two ends of the first connecting piece 51 and the lengths of the two ends of the second inner side 21 are both the same. The fastening portion 52 is provided on the first connecting piece 51, so that after the fastening portion 52 is embedded in the locking cavity 43, the opening of the bag is almost sealed, and there is no unsealed portion between the first bag sheet 1 and the second bag sheet 2.

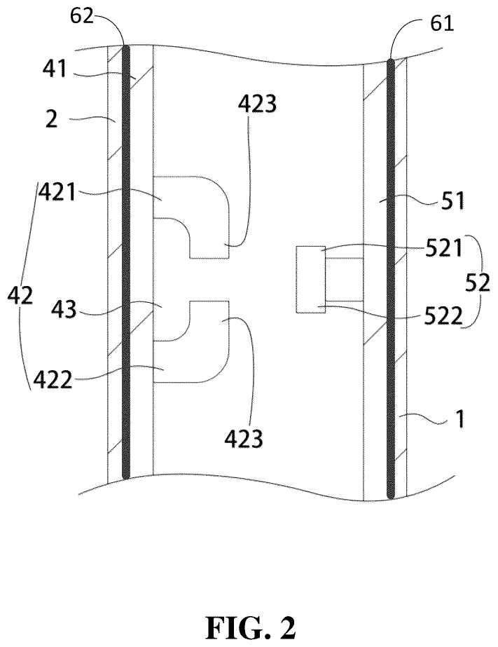

The fastening portion 52 is equipped with a first raised area 521 and a second raised area 522, and the first raised area 521 and the second raised area 522 are specifically symmetrically provided on the fastening portion 52. A first end of the first raised area 521 is connected to a first end of the second raised area 522, and a second end of the first raised area 521 and a second end of the second raised area 522 extend partially in an opposite direction. According to what is shown in FIG. 2, the first raised area 521 or the second raised area 522 is vertically disposed with the fastening portion 52. When the fastening portion 52 is embedded in the locking cavity 43, the locking element 423 of the first locking portion 421 catches the second end of the first raised area 521, and the locking element 423 of the second locking portion 422 catches the second end of the second raised area 522, so that the entire fastening portion 52 is secured by the locking portion 42.

The first inner side 11 and the second inner side 21 are both provided with an adhesive layer 6. The adhesive layer 6 of the first inner side 11 is specifically disposed at the opening of the bag on the first inner side 11, while the adhesive layer 6 of the second inner side 21 is also disposed at the opening of the bag on the second inner side 21. The second connecting piece 41 is provided on the adhesive layer 6 of the first inner side 11 and the first connecting piece 51 is provided on the adhesive layer 6 of the second inner side 21. The second connecting piece 41 is fixed to the adhesive layer 6 of the first inner side 11 and the first connecting piece 51 is fixed to the adhesive layer 6 of the second inner side 21 by means of heat treatment. The adhesive layer 6 of the first inner side 11 is provided opposite to the adhesive layer 6 of the second inner side 21 so that the fastening portion 52 is just embedded in the lock portion 42 when the opening of the bag is sealed.

In addition, the adhesive layer 6 does not take up an excessive amount of area on the first inner side 11 or the second inner side 21, and when it is subsequently necessary to recycle the bag, it is only necessary to tear off the adhesive layer 6 on the first inner side 11 and the adhesive layer 6 on the second inner side 21.

The outer diameter of the first bag sheet 1 matches that of the second bag sheet 2, and specifically the length of the upper and lower ends and the left and right ends of the first bag sheet 1 is the same as the length of the upper and lower ends and the left and right ends of the second bag sheet 2, respectively. Therefore, after the connecting end 3 of the first bag sheet 1 is connected to the connecting end 3 of the second bag sheet 2, there will not be an extra portion of the connecting end 3 of the first bag sheet 1 or the connecting end 3 of the second bag sheet 2 that is not connected to the corresponding connecting end 3.

The first bag sheet 1 includes a first tear-off bag sheet 12 with the first locking member 5 placed thereon, and a first tear-off line 121 is provided at the juncture of the first tear-off bag sheet 12 with the first bag sheet 1. For subsequent recycling of the paper packaging bag with a ziplock, it is only necessary to separate the first tear-off bag sheet 12 from the first bag sheet 1 along the first tear-off line 121 in order to remove the first tear-off bag sheet 12 so that the first bag sheet 1 can be recycled.

The second bag sheet 2 includes a second tear-off bag sheet 22 with the second locking member 4 placed thereon, and a second tear-off line 221 is provided at the juncture of the second tear-off bag sheet 22 with the second bag sheet 2. For subsequent recycling of the paper packaging bag with a ziplock, it is only necessary to separate the second tear-off bag sheet 22 from the second bag sheet 2 along the second tear-off line 221 to remove the second tear-off bag sheet 22, so that the second bag sheet 2 can be recycled.

The above descriptions are merely the detailed embodiments of the present application, but the scope of protection of the present application is not limited thereto. Various equivalent modifications or substitutions may be made by those skilled in the art on the basis of the above-mentioned embodiments of the present application. These modifications or substitutions shall fall within the scope of protection of the present application. Therefore, the scope of protection of the present application is defined by the appended claims.

What is claimed is:

1. A paper packaging bag with a ziplock, comprising:
a first bag sheet and a second bag sheet formed by folding a paper material, wherein each of two vertical edges of the first bag sheet comprise a connecting end, each of two vertical edges of the second bag sheet comprise another connecting end, and the connecting end of the first bag sheet is disposed opposite to and connected with the connecting end of the second bag sheet, thereby defining a containing cavity configured for holding items;
a ziplock disposed at an opening of the containing cavity, the ziplock comprising a first locking member and a second locking member that are configured to be snap-fitted to each other; and
a first paper connecting strip and a second paper connecting strip, each of which comprising a paper strip, a hot-melt adhesive layer disposed on one side of the paper strip, and a film layer disposed on the other side of the paper strip;
wherein the first paper connecting strip is disposed between the first locking member and the first bag sheet, the hot-melt adhesive layer of the first paper connecting strip faces a first inner side of the first bag sheet, and the film layer of the first paper connecting strip faces the first locking member; the first locking member is fixed to the first inner side of the first bag sheet via the first paper connecting strip by means of hot-pressing treatment;
the second paper connecting strip is disposed between the second locking member and the second bag sheet, the hot-melt adhesive layer of the second paper connecting strip faces a second inner side of the second bag sheet, and the film layer of the second paper connecting strip faces the second locking member; and the second locking member is fixed to the second inner side of the second bag sheet via the second paper connecting strip by means of hot-pressing treatment.

2. The paper packaging bag with a ziplock according to claim 1, wherein the hot-melt adhesive layer is covered on one side of the paper strip by means of a printing process.

3. The paper packaging bag with a ziplock according to claim 1, wherein the film layer is covered on the other side of the paper strip by means of a coating process.

4. The paper packaging bag with a ziplock according to claim 1, wherein both the film layer and the ziplock are made of Polyethylene.

5. The paper packaging bag with a ziplock according to claim 1, wherein the first locking member comprises a first connecting piece and a fastening portion disposed on the first connecting piece, the first connecting piece is disposed on the first inner side of the first bag sheet and extends along both ends of the first inner side of the first bag sheet.

6. The paper packaging bag with a ziplock according to claim 5, wherein the first connecting piece is combined with the film layer of the first paper connecting strip by means of hot-pressing treatment.

7. The paper packaging bag with a ziplock according to claim 6, wherein the width of the film layer of the first paper connecting strip is greater than or equal to the width of the first connecting piece.

8. The paper packaging bag with a ziplock according to claim 1, wherein the second locking member comprises a second connecting piece and a locking portion disposed on the second connecting piece, and the second connecting piece is disposed on the second inner side of the second bag sheet and extends along both ends of the first inner side of the first bag sheet.

9. The paper packaging bag with a ziplock according to claim 8, wherein the second connecting piece is combined with the film layer of the second paper connecting strip by means of hot-pressing treatment.

10. The paper packaging bag with a ziplock according to claim 9, wherein the width of the film layer of the second paper connecting strip is greater than or equal to the width of the first connecting piece.

11. The paper packaging bag with a ziplock according to claim 8, wherein the locking portion comprises a first locking portion and a second locking portion, one end of the first locking portion being disposed opposite to and separated from one end of the second locking portion by a predetermined distance so as to form a locking cavity for securing the first locking member.

12. The paper packaging bag with a ziplock according to claim 11, wherein the first locking portion and the second locking portion are both provided with a locking element, and the locking element of the first locking portion and the locking element of the second locking portion both extend at least partially toward the locking cavity;
when the first locking member is embedded in the locking cavity, the first locking member is secured by means of the locking element of the first locking portion and the locking element of the second locking portion.

13. The paper packaging bag with a ziplock according to claim 1, wherein the first bag sheet comprises a first tear-off bag sheet with the first locking member placed thereon, and a first tear-off line is provided at the juncture of the first tear-off bag sheet with the first bag sheet;
the second bag sheet comprises a second tear-off bag sheet with the second locking member placed thereon, and a second tear-off line is provided at the juncture of the second tear-off bag sheet with the second bag sheet.
